(19) United States
(12) Patent Application Publication
(10) Pub. No.: US 2004/0006549 A1
(43) Pub. Date: Jan. 8, 2004

(54) Micro edition dynamic object-driven database manipulation and mapping system

(76) Inventors: Ward Mullins, San Francisco, CA (US); Robert Boucher, Cathedral City, CA (US)

Correspondence Address: Robert G. Lev, 4766 Michigan Boulevard, Youngstown, OH, 44505, US

(21) Appl. No.: 10/396,216

(22) Filed: Mar. 24, 2003

Related U.S. Application Data
(60) Provisional application No. 60/367,117, filed on Mar. 22, 2002.

(51) Int. Cl. G06F 17/30

(52) U.S. Cl. 707/1

(57) ABSTRACT

The present invention provides a micro computer system and method for dynamic object-driven database manipulation and mapping system which relates in general to correlating or translating one type of database to another type of database or to an object programming application. Correlating or translating involves relational to object translation, object to object translation, relational to relational, or a combination of the above. Thus, the present invention is directed to dynamic mapping of databases to selected objects that can be used on both a micro computer system and in a larger computer system. Also provided are systems and methods that optionally include caching components, security features, data migration facilities, and components for reading, writing, interpreting and manipulating XML and XMI data files.

### TECHNICAL FIELD

The present invention relates in general to correlating or translating one type of database to another type of database or to an object programming application in a micro or hand held computer system such as Palm and the like. Correlating or translating involves relational to object translation, object to object translation, relational to relational, or a combination of the above. Thus, the present invention is directed to dynamic mapping of databases to selected objects of a programming module.

### BACKGROUND ART

Computer databases or similar constructions (hereinafter referred to as data stores) are powerful tools for storage, organization, retrieval and other handling of various types of information. However, there are different database models, or formats, for data access that are incompatible with each other, and may also be incompatible with, or remarkably different from, an object programming application. Also, the database models for desktop or mainframe computer systems are different from hand held computer or micro devices. In this respect, complex relationships between objects present in the object programming application may be entirely absent in a relational or object database being accessed or updated. In fact, databases are often tightly bound to applications on microcomputer devises that run object based computer languages such as Java.

A plurality of database types have achieved a high level of popularity and proliferation. The two most common database models are object and relational, and object programming models are frequently used for internet applications involving database accessing.

Currently, there is no known solution for easily using a single relational or object database for multiple object programming applications in a microcomputer environment. There is a strong need for an object to object, object to relational, and relational to relation database and programming access translation using an abstraction layer. There is also a need to provide persistence of data from create, update and delete functions relating to the database. Also, there is a need for code generation based upon maps of object schema, database schema, and their relationships that permits the reuse of objects and for different programming applications to access the same data source or to synchronize multiple data sources.

As an example of common object programming applications, the popular Java language with its server-side component, Enterprise Java Beans, is being widely used to support object model programming applications that access and use data from databases that have a JDBC driver. Micro editions of the Java language are available such as the standard IBM micro edition of Java (does not ordinarily precompile Java objects to micro computer programming code, dynamic translation of Java by the Java Virtual Machine “JVM”) and the special vendor version of micro edition named JBED (precompiles Java classed to micro computer programming code, static translation of Java by the Java Virtual Machine “JVM”). Also, JDBC relational databases such as the “PointBase” database are available for microcomputer devices, such as PALM and the like.

Thus, it is desirable to be able to adapt and use many of the traditional relational database tools, utilities, systems and corporate procedures with the newer object format of many more recent local system or web-based applications in a microcomputer environment. Since many users may be accessing and updating a single database of an enterprise level or corporate system, there is a need for a means to persist data from the microcomputer to a non-micro edition database that may be accessed by multiple users. There is a need to for synchronizing object programming application transactions with database accesses and updates. There is a need for such a solution to provide for more efficient eCommerce and other database driven business solutions on microcomputer devices.

Systems for accessing data storage based upon objects have been used for many years to accommodate object-directed software applications. The most common conventional approach to accomplish access of data stores involves writing and embedding custom access codes within an object application needing access to the data. This approach is generally limited to having custom codes capable of accessing only a single relational table within a relational database or similar construction, referred to as a data store. When an object model has been adapted specifically for accessing a single data store using the JDBC driver for that data store, moving data to a second database or accessing multiple databases can become very problematic and painful for a programming engineer who is assigned the responsibility for such a task.

The aforementioned conventional approach to bridging between object and relational models (or between object and multiple relational models) has frequently required “brute-force” hand-recoding of relational database access code. This approach can be very time-consuming and is prone to errors. This approach can also generate inefficient objects that require more processing time, storage space, and transfer time. Further, this approach does not scale well because each instance of relational access code must be converted manually, in turn, even if similar objects have already been applied for use with the converted relational data base.

As mentioned above, more efficient approaches sometimes use tools to automate the conversion process. However, the tools provided to date typically are not versatile enough to handle many types of conversion without manual coding or explicit defining of parameters by a human operator. Because of this requirement for operator participation in the translation, the conversion using today's tools still does not scale well and does not allow for fully automated and flexible conversion of data access between various data base models.

Further, this approach to conversions does not provide for communicating the conversions in an efficient manner as, for example, to other entities who may need the same type of conversion on similar data, or who may require the conversion to access the data in another way. In a distributed environment that may involve multiple users accessing multiple databases by multiple object applications, this can get exceedingly complex. Another drawback of conventional systems and techniques (as understood in the conventional art), is that dynamic mapping of objects to multiple types of databases is virtually impossible, because the tailored hand code must be updated and recompiled. This may require that an application be stopped, rebuilt, repackaged and restarted in order to implement mapping changes, i.e., the mapping changes are not dynamic.

Significant drawbacks are associated with using a relational database model in conjunction with an object programming model, but the relational database model is still the most widely accepted traditional format for reliable and quick access to data while using complex data search queries. This model allows the user to store data records and to access the data via a query language that uses relational expressions such as =, LIKE, AND, OR, NOT, etc. Over the years, the vast majority of production databases have been relational databases, each having its own relational arrangement, and accessible by a particular query language. While convenient for set-up and arranging data, access is had only by those having substantial knowledge of the various relationships between pieces of data in the database.

JDBC drivers have been designed to formulate database specific SQL queries or statements from standard SQL strings passed to them by an object programming application. Ordinarily, such JDBC drivers are specific to a database, and separate statements and separate JDBC drivers must be utilized to access different databases. This is complicated by the fact that many object programming applications either do not permit simultaneous attachment to multiple databases or poorly coordinate transactions that impact multiple databases. Accordingly, relational databases can sometimes be awkward to access, and transferring data from one database to another database can be slow and painful, unless a specific transfer program has been specifically written or tailored to effect that specific transfer of data.

The object database model is a newer model that has rapidly increased in usage due to recent trends such as the world-wide-web and application service provider (ASP) architectures. Such object databases have sometimes been used as the primary source for accessing data, for example, Jasmine and ObjectStore are available from Computer Associates Intl., Inc. and Object Design Inc. (ODI), respectively. However, accessing data in such permanently stored object database has raised serious performance issues for larger applications when complex querying is required (as compared to relational databases). Complex querying is usually faster using relational databases since query engines may be more highly developed for relational database accesses.

Accordingly, intensely needed by many modern software application programs are systems both micro computer systems and larger computer systems for more efficient access and manipulation of data stores, systems having the flexibility and dynamic capability to attach data from a database to maps as objects and having the ability to map one or more databases to various objects in real time, and to persist and synchronize data between data systems. A strong need exists for such systems that also permit a user to cleanly, transparently and synchronically transfer data between multiple data sources, sometimes on different computer systems, while maintaining the ability for an object programming application to access or use such data in the system. The need exists for an improved database access buffering system, for object programming applications, having at least one transparent secondary memory resident database and a primary data source that can be simultaneously utilized in a synchronized and transaction coordinated manner.

### SUMMARY OF THE INVENTION

Accordingly, it is an object of the present invention to overcome the drawbacks of the conventional art and achieve flexibility and dynamic operation in the accessing of databases on both micro computers and larger computers that has not yet been achieved on a consistent basis.

It is another object of the present invention to provide a system for dynamically mapping data to objects for software applications in a micro computer environment that can run an object programming language virtual machine.

It is a further object of the present invention to provide a system for mapping to an object for a software application during the run time of that application, and/or to pre-compile Java classes in a micro computer language.

It is an additional object of the present invention to provide easy translations between databases and applications having a variety of different formats or data store models on both micro computer and larger computer systems.

It yet another object of the present invention to provide a mapping system wherein multiple objects can be used for a particular map in a micro computer system.

It is still a further object of the present invention to provide a mapping system wherein multiple maps can be developed for a single object in a micro computer system.

It is again another object of the present invention to provide a mapping system wherein different data attached to an object can be selected by means of different maps in a micro computer system.

Another object of the present invention is to provide a mapping system in a micro computer system, wherein object programming applications are tailored to delegate accessing a database and the generation of SQL strings to a runtime library and repository, which library can access the database directly or through a database driver, such as a JDBC driver, without the need to embed specific database accessing mechanisms in the application code.

It is a preferred object of the invention to provide such a micro computer system with a concurrent parameter setting mechanism where the runtime library repository can be set to access a particular database and to generate database specific database calls and SQL strings.

In one preferred object of the invention, a software program would be provided that can generate application programming code from database maps to provide a programming application for the micro computer system that will delegate to a runtime library repository the functions of accessing a database and the generation of SQL strings that are specific to a database or JDBC driver.

In another preferred object of the invention, the runtime library repository of the micro computer system can be modified and tailored to optimize database access calls and SQL strings for a particular database.

In another object of the invention, a Enterprise Java Bean, such as Session Bean, is provided that is designed to be modified and tailored to use the runtime library repository of the micro computer system in combination with object programming model schema and definition(s) to provide a consistent persistence model for the complete enterprise system, including the micro computer system. A preferred object of the invention is to provide seamless coordination of the data source or object model in a microcomputer with at least one larger computer system by designing databases that utilize data types in programming applications that are acceptable to the operating systems of both computer systems.

Another object of the invention, is to provide a GUI and command line or API interface to an object to relational programming tool suite that can utilize a map or an object programming schema of objects and relationships definitions from a microcomputer system or a compatible larger computer system to generate an object programming application or component such as Java Classes, JSP, EJB, Session Bean, EAR file or WAR file that will run on the micro computer system. Such generated applications may be designed or may be modified and tailored to use the runtime library repository of the microcomputer system to provide a consistent persistence model for the complete enterprise system, including the microcomputer system. A preferred object of the invention is to provide seamless coordination of the data source or object model in a microcomputer with at least one larger computer system using such an application.

It is still an additional object of the present invention to provide a mapping system wherein different maps for particular objects can be used to provide varying levels of security.

It is again another object of the present invention to provide a mapping system wherein data changes related to a particular object can be promulgated with global changes for that object, if desired.

It is still a further object of the present invention to provide a mapping system when a data map for an object can be easily edited without extensive knowledge of the relational database as a source of the data.

It is again another object of the present invention to provide a mapping system wherein the metadata describing a map of a datastore can be dynamically evaluated.

It is again another object of the present invention to provide a mapping system, wherein data can be accessed more quickly than is possible with a conventional data store accessing arrangements.

It is again a further object of the present invention to provide a mapping system in which frequently-used data can be more easily accessed than other types of data.

It is yet a further object of the present invention to provide a mapping system in which a wide variety of different data languages can be easily used.

It is still a further object of the present invention to provide a mapping system wherein virtually any type of datastore architecture can be translated so as to be useful by an object software application, or other types of software applications.

It is again a further object of the present invention to provide a mapping system wherein datastore to datastore mapping is easily facilitated.

It is still another object of the present invention to provide a fully synchronized caching system that utilizes the transaction coordination facilities of a server such as a J2EE application server (for example, Weblogic 6.1), such system comprising a local or distributed computer system having a first data source referred to as the primary data source, a second data source referred to as the cache data source and the cache data source is associated with an object to relational mapping layer to provide a data source cache for object applications, and a server having a transaction coordinator with the ability to register multiple data sources, wherein:

(a) both the primary data source and the cache data source are registered with the transaction coordinator facilities of the server, and

(b) the cache data source acts as secondary data source to speed up data accesses for an object application and the cache data is plugged into the object to relational mapping layer, and

(c) registration of the cache data source with the transaction monitor of the server provides the feature that any changes to the cache will automatically be synchronized with the primary data source or record upon transaction completion, including commit or roll-back of changes for both data sources.

In a particularly preferred object of the invention the cache data source can be set up as a memory-resident entire database, a disk resident database, or both a memory resident database and disk resident which are synchronized. In one object, of the invention the memory resident database may be a portion of the disk resident database and the size of the memory for the memory resident database can be set by the user.

Another object of the present invention is to provide a database access repository, or a collection of repositories, comprising a runtime library repository having the ability to make database specific calls and to generate database specific SQL strings, and comprising other libraries, information and logic that permit mapping of information related to one or more of a member selected from the group consisting of relational databases, object databases and object programming schemas, and the like. The database access repository may contain one or more items selected from the group consisting of maps of database schemas, object definitions, other programming definitions or parameters, object metadata, database settings, complex relationship definitions. For example, metadata can be placed in a separate structure from the java object application and can be independently stored and accessed in a database access repository file collection, or in a separate file or location. In one preferred object of the invention, an object to relational repository can include a runtime library repository that can be optimized for a particular database and has the ability to access multiple database types, wherein the runtime library repository can be access by object programming applications that delegate database access and SQL string generation to the runtime library repository.

These and other objects and goals of the present invention are achieved by the present invention as described below, and depicted in FIG. 7.

In some objects of the present invention, concepts are based in part upon concepts present in U.S. Pat. No. 5,857,197, (incorporated herein by reference) or that are reasonably inferable from reviewing that patent, in order for the present invention to provide an improved mapping system for handling data requested by an object software application model in a manner that is compatible with relational data stores. A dynamic repository-based mapping system is used. The system does not put all of the data access code in java objects, for example metadata (data about java objects including complex java objects that have relationships with other java objects) does not need to be stored in a java object. In a preferred aspect, it is an object of the present invention to provide a database access system that does permits a java object application to delegate database accesses to a runtime library repository.

In a preferred object of the present invention, a software programming module (or modules) can automatically generate object source code from at least one database schema map, at least one object programming application schema, or from a combination of at least one database schema map and at least one object programming application schema. The code generated for the application can be set to delegate database access and SQL string generation to the runtime library repository instead of including within the application the more limiting code for non-delegated database access by the application. This arrangement allows the mapping information and associated metadata to be easily accessed, changed and used to convert thousands of lines of code in a data object, as needed. The mapping information can be used to map from objects to relational models or vice versa and generate appropriate code.

### Definitions

For the purposes of the present application, the following definitions are given as a meaning for terms used herein throughout this application to avoid any confusion with possible multiple meanings for such terms. Other terms used herein have meanings that are well recognized in the art, and their meanings will be clear from the context in which they are used in this application.

A “module” in the computer programming context is an organized set of computer code designed to act on some externally passed in data, where everything needed for that action is passed in to the module.

An “object” in the object oriented programming context is an organized set of encapsulated programming code designed to act on itself at the request of some external system, which system may pass in some additional information to the object when it delegates a task to the object in that request.

A “composite object”, or an object programming “component”, in the object programming context each refer to an object comprising a complex and organized set of objects that are encapsulated to form the composite object. The two terms “composite object” and “component” (e.g., a J2EE component such as an EJB, Enterprise Java Bean) may be utilized in an interchangeable manner in referring to the same type of logical constructs and concepts.

A “delegation” in the object oriented programming context is where an object or a programming application permits another simple object, set of objects, composite object, or a module to perform an action by simply requesting the action from the delegated simple object, set of objects, composite object or a module.

A “non-delegation” database access in the object oriented programming context is where an object or a programming application has specific code embedded in the application which directly controls database calls and the generation of SQL strings, wherein the embedded code is specifically tailored for accessing a particular database or for a specific database schema.

A “user interface” for an object oriented application, such as a Java Server Page (JSP), a Swing GUI, and the like, refers to a software component or module that provides a feature for a user that will permit the user to interact with an object or programming application in some way, such as the interactions of finding, selecting, inserting, updating and deleting data in a database.

A “library” is a set of definitions, data, objects or programming modules that may be accessed by a computer programming application to obtain information or to delegate tasks.

A “repository” in the object programming context and in the context of this application is a special set of libraries that may include, among other things, items related to object to object mapping, object to relational mapping and database accessing information, database parameters, optimized database access routines, and the like. A repository may be a single file or may be a set of files that is local or in another location such as a database or set of database tables and fields. The format of items in a repository may vary widely according to the desire of a computer programmer user or developer and may be in one or more of formats such as simple text, XML, XMI, UML, JDBC accessible information such as tables and fields, source code, compiled code, and the like.

A “micro computer system” in the context of the specification and claims of this application refers to either an embedded device in an electronic system or a standalone computer system weighing less than 3 pounds and having length and width dimensions not greater than 8 inches per side. An example of a preferred stand-alone micro computer system is a light-weight hand held computer, and more preferred are such devices having phone-linked internet systems. Non-limiting examples of micro computer systems are cell phones, smart phones, very small mini computers or personal organizers, personal digital assistants (“PDAs”) and embedded devices. Non-limiting examples of PDAs are a Palm Pilot, a Sony Clie, a Pocket PC, and the like. Non-limiting examples of embedded devices are phones; automobile computing systems; home sound systems; home, auto, or commercial electronic security systems; smart video game consoles; etc.

### DETAILED DESCRIPTION OF THE PREFERRED EMBODIMENTS

The present invention is based in part on U.S. Pat. No. 5,857,197, (incorporated herein by reference), and provides a mapping system for handling data requested by an object software application model in a manner that is compatible with relational data stores. A dynamic repository-based mapping system is used. The system does not put all of the data access code in java objects, for example metadata (data about java objects including complex java objects that have relationships with other java objects) does not need to be stored in a java object. Instead, the mapping information related to object definitions and some metadata can be placed in a separate structure that is independently stored. This allows the mapping information and associated metadata to be easily accessed, changed and used to convert thousands of lines of code in a data object, as needed. Mapping information can be used to map to and from objects to relational models, objects to objects, object to COBOL or vice versa, and object to XML and the like.

In one embodiment the present invention provides a micro computer system comprising at least one data source and a mapping system wherein object programming applications are tailored to delegate both the accessing of a data source and the generation of SQL strings to a runtime library repository, which repository can access the database directly or through a database driver, such as a JDBC driver, without the need to embed specific database accessing mechanisms in the application code. In a preferred embodiment the micro computer system is an embedded device that is a portion of a larger system other than a traditional desktop or laptop computer. The micro computer system may be an embedded system present in a portable or cellular phone, an automobile computing system, part of a home electronic sound or entertainment system, a portable sound or entertainment system, an electronic security system, a smart video game console, or a combination thereof. Also, the micro computer system may be a standalone computer system other than a traditional mainframe, desktop, or laptop system. The standalone computer may be a smart mobile phone, a personal organizer, a portable stock market trading device, a hand held computer or a PDA. In a preferred embodiment the micro computer system is standalone computer as described above that is either adaptable to or includes the ability for portable internet access, mobile telephone communications, satellite communications or a combination thereof.

A preferred micro computer system is as described above, having a concurrent parameter setting mechanism wherein the runtime library repository can be set to access a particular data source and to generate data source specific database calls and SQL strings.

Another preferred micro computer system is as described above, wherein the mapping system portion is designed to provide different maps for particular objects to different users and does not permit direct access of computer system users to JDBC drivers for any mapped data sources of the computer system, and wherein the mapping system provides varying levels of access to the mapped data sources for at least two different users of the same system, whereby a user only has access to a particular list of maps that are available to the security level of that user. A preferred embodiment provides such a micro computer system, wherein the mapping system portion is designed to provide to a system user who is accessing, creating or updating maps, or accessing objects on a system to make data changes related to a particular object and to promulgate the changes to that object as either local or global changes on the computer system.

Another preferred micro computer system is as described above, wherein the mapping system portion provides an interface permitting an authorized user to edit or create the tables, fields, or attributes of a data map for an object as a table format or XML file format without requiring the user to have extensive knowledge of a particular relational database as a source of the data, or extensive knowledge about how to directly access that relational database. A preferred embodiment is such a system, wherein the mapping system provides an interface and features that permit a user to access, create, or update the metadata of a map as a dynamic computer system update, without requiring the user to either open a new connection to the data source or to restart an object application program that is running while the user is dynamically evaluating or changing metadata for a map, and wherein the metadata of a map that a user can dynamically evaluate or change includes a map description of data or relationships between data, and wherein such map description is at least one member selected from the group consisting of a data source relationship, a relationship between at least two objects of an object application, and both a data source relationship and a relationship between at least two objects of an object application.

In a preferred embodiment there is provided a local or distributed computer system which is a system connected by intranet, internet or satellite communication systems, or a combination thereof, wherein the local or distributed system includes a micro computer system or an embedded system comprising a fully synchronized data system and an O/R repository that permits persistence and synchronizing of data between a data source on the micro computer system and a main data source on a larger computer system. In a more preferred embodiment the local or distributed system further comprises a mapping system wherein object programming applications are tailored to delegate both the accessing of a data source and the generation of SQL strings to a runtime library repository, which repository can access the database directly or through a database driver, such as a JDBC driver, without the need to embed specific database accessing mechanisms in the application code, and wherein the persistence manager calls the mapping system and in the call delegates accessing or updating of data in the data source to the repository layer, and wherein the a persistence monitor does not complete a transaction until it is notified by the mapping system that a data source has been updated by the mapping system such that any changes to the data will automatically be synchronized with the primary data source or record upon completion, including commit or roll-back of changes for both data sources.

In a particularly preferred embodiment, the invention provides a computer system as described above, wherein at least one temporary data source can be set up on a microcomputer system or embedded system and is synchronized via a persistence monitor with a data source on a larger system wherein the larger system can be accessed by a JDBC driver and is not merely a duplicate of the micro computer system data source.

In another embodiment, the invention provides an object language software program that can run in any one of the micro computer system described above, or in a virtual machine that emulates such a micro computer system, and can generate application programming code from database maps and thereby provide a programming application that will run on a micro computer system, which delegates to a runtime library repository both of the functions of accessing a database and generating SQL strings that are specific to a database or to a JDBC driver for a type of database. In a preferred embodiment, the object language software program as described above operates with a runtime library repository that can be modified and tailored to optimize database access calls and to optimize the generation of SQL strings for a particular database. In a particularly preferred embodiment, the invention provides an object language software program as described above, wherein the software program provides the ability to synchronize internal data and/or objects on the micro computer or virtual machine emulator system with an external data store and to provide transparent persistence of data and/or objects between the internal and external data stores.

In a particularly preferred embodiment, the invention provides an object language software program as described above, wherein the synchronization and transparent persistence is implemented through communications between directly connected computer systems or through indirectly communicated machines via telephone, intranet, internet, or satellite communications, or through a combination of such communication and connection types.

Certain of the embodiments of the present invention are embodied in a suite of products by Thought, Inc., referred to as “CocoBase”. Aspects of the CocoBase technology are also described in U.S. Pat. No. 5,857,197, supra. Also, a number of details of the system of the present invention are provided now as state of the art in the documents that have been posted on the website of Thought, Inc. or are otherwise available on the internet as publications.

In one embodiment, the mapping information, rules, or metadata can be maintained in a human-readable format and can be interpreted by an application to apply the rules to data objects. This information can be stored directly in the data source or can be stored in a separate file. In either case, this information is called a “repository”. This repository provides an easily maintainable and transportable format for the mapping rules. The rules and java object relationships can be updated, or otherwise changed, dynamically even while other rules or object relationships in the repository are being used to perform conversions. The rules and relationship definitions can be embedded in standard formats such as in Java code, e-mailed, sent as plain text, etc. This allows for flexible transfer and proliferation of the rules to other sites where the rules can be used to access objects (which can be bundled with the rules), used to derive other rules, etc. In a particularly preferred embodiment, this repository is in an XML (extensible markup language) format, and the object model definitions can also be present in an XMI (XML metadata interchange) format or can be easily exported to an XMI file format.

A more preferred embodiment is such a system and software as provided by an updated CocoBase Enterprise Object/Relational Software package (hereafter CocoBase), which includes the software tool CocoAdmin. Such updated software package, is available, or is available shortly, from Thought, Inc., San Francisco, Calif. An embodiment of the invention using this package is described below.

Exporting Maps as XML Repositories in CocoBase

CocoAdmin provides a mechanism for the export of maps defined against a database into a modifiable XML format. This facility allows a system user to select an existing map(s) to be exported, and to also specify the filename of the XML document to be created. The resulting XML document is written to a file with the specified filename using an XML template named coco.dtd that is ordinarily located in the thought\cocodemo3tier31\demos\resources directory.

Once the XML file is written, it can be edited using a standard text editor or XML editor, and can be modified to reflect map customization requirements. The following discussion relates to specific features of the generated XML file.

The basic repository format has CBObject (CocoBase object class) definitions that reflect the select, insert, update, delete and call related map definitions for a CocoBase map. Each of those operations further consists of tables, fields and clauses that may exist to specify how the object is mapped to and from the data source.

XML files contain a DTD (document type definition) entry which describes the structure of the tags and data contained in the file. The DTD only checks for the existence of required elements, but doesn't check the contents of those elements. Given this desired degree of freedom, it is possible to enter invalid map information which will not be processed properly by the CocoBase runtime and care should be exercised to avoid improper editing. In general, modifications should be restricted to the schema, table, and field name variables in the Tables and Fields entries. These variables may require different values when they are exported from one database instance, and imported into another.

To begin exporting a set of maps, select File->Export XML Map Repository from the CocoAdmin pull-down menu. Multiple maps can be selected by holding down either the <Shift> or <Control> when selecting the connection and map(s) to export.

When Next> is pressed in the dialog box provided, the list of selected maps will be presented in a list and the window will prompt for a final acknowledgement of export. The XML repository filename including the directory path can be specified in this window. If the directory path is not specified, the XML repository will be written to the thought\cocodemos3tier31\demosdirectory. When the Export XML>button in the dialog is pressed, CocoBase creates the XML file in the specified directory. After the document has been written to the disk a dialog appears which acknowledges that the repository has been created.

Importing Maps from XML Repositories Using CocoBase

CocoAdmin provides a mechanism for importing XML based CocoBase map definitions, or for importing an XMI object model definitions and then generating corresponding XML based CocoBase map definitions. Using the XML syntax defined in the thought\cocodemo3tier31\demos\resources\coco.dtd template file, CocoAdmin can import maps previously defined and exported from a different database or from a different object instance. The XML files generated from CocoAdmin will be validated against the DTD, and a basic syntax check will occur. No in depth syntax checking will occur because of the flexibility allowed in the system. When an import of an XML map definition occurs, it is in relation to an open database connection.

To begin importing an XML map definition from the CocoAdmin GUI select File->Import XML Map Repository from the pull-down menu or Import XML Map Repository from the popup menu in the main CocoAdmin dialog. Import an XML based map definition by selecting the database connection into which the import is to occur, and click the Browse button to find the XML repository file to be opened. After a file is selected the dialog button Load XML Document is clicked and the selected XML filename appears in the initial Import dialog. After the Next> button is pressed, the selected maps are compared with those already in the database. If a newer version of a map already exists in the database, by default a flag is set to retain the newer version. If the maps being imported are newer than the ones already in the database, then by default, a flag is set to import each of the newer ones. When the comparison operation is completed the user can override any flags before the task is initiated. For example, if the XML maps are older than the versions already in the database, this condition causes the Already Exists? flag to be checked and the XML map definitions will not be imported unless the user overrides this flag by checking the Import/Overwrite? box.

When a user clicks the Import XML Repository button as described above, maps marked for import will automatically be integrated into the list of maps in the CocoBase repository for that database. If the imported maps do not reflect the physical structure of the underlying database, they may need to be manually edited by the map editor before using them with an application. Also, XML format maps can be edited before they are imported. For example, an XML editor or any standard text editor can be used for this operation. Most common edits consist of changing column names, table names, and less frequently, the schema names of the tables and the fields that the map may access.

The CocoBase Programmer's Guide available at the www.thoughtinc.com website provides further information about how to work with XML format maps and CocoBase, which published document is incorporated herein by reference. This document also explains how to set CocoBase (or CocoAdmin of CocoBase) and its runtime modules to cache maps that an application will be using in order to speed up user access. Other user hints and instructions are provided therein. For example, one URL option in CocoBase is to specify an XML repository for the maps that an application will be using. Instead of using the database repository, the runtime can use an XML repository exclusively. This technique allows CocoBase to execute against a production database that cannot be modified with map definition tables. Optional mapping server plug-ins are also described.

Data source maps according to the present invention may be utilized to generate application programming code, such as Java source code. For example, the CocoAdmin tool will allow a user to generate Java for a range of targets including most commercial Application Servers and Enterprise Java Bean Servers. A complete list of pre-configured targets can be viewed from the Connections window in the Generate Java wizard of CocoAdmin. Any Java class can readily be used with CocoBase, whether or not it was generated by the CocoAdmin tool. However, there may be significant advantages that occur from using the code generation facilities of CocoBase to quickly generate your Java classes. For example, the disadvantages inherent with data source specific non-delegation database access code can be avoided by generating code, which delegates the database access functions to CocoBase runtime libraries. Only CocoBase is believed to utilize this type of code that results in dynamic O/R mapping system capabilities.

The CocoAdmin tool can use a combination of the map definition and database foreign key relationships (if any exist) to define how the Java class is going to be generated. The Generate Java wizard of CocoAdmin can be started in one of four ways to generate Java code from a CocoBase map.

1. Clicking the on the coffee pot icon located on the CocoAdmin tool bar.

2. Selecting File->Generate Java Code from the CocoAdmin pull down menu.

3. Selecting Generate Java from Existing Map from the launch pad after a connection has been made to a database repository, then clicking Launch.

4. Right clicking in the CocoAdmin main window and selecting Generate Java Code from Map from the pop-up menu.

From the connections directory tree in the Generate Java wizard, select the map from which a Java class will be generated. From this window, the CocoAdmin user can also set flags to automatically generate code that does one or more of the following:

Supports the transaction object (check TransObj).

Uses existing foreign keys to automatically determine object relationships (check ForeignKeys).

Uses the CBDrop, CBProp or both of CocoBase persistence interfaces (check CBProp and/or CBDrop).

The CocoAdmin user can also (optionally) enter in a package prefix at this point. Java classes are typically organized into packages, which are stored in a common directory. The package prefix (entered at the Pkg Prefix: prompt) will then refer to the directory in which the Java code will be stored.

The Code Generation Template drop-down list of the CocoAdmin code generation wizards allows a CocoAdmin user to select a target for the classes (Java code) that will be generated for a member of the comprehensive list of targets. The following target categories are supported for most commercially available application servers and EJB servers.

Java for distributed objects and application server applications.

Enterprise Java Beans with Bean Managed Persistence (BMP).

Enterprise Java Beans with Container Managed Persistence (CMP).

The Generic EJB Entity Bean CMP—All Parts option from the drop down of CocoAdmin will generate a completely standard CMP Bean, which can be installed using any vendor supplied CMP installer. CMP concepts for EJBs are discussed in a variety of documents published in this field, including in the appropriate section of the CocoBase Programmers Guide. In order to take full advantage of the CocoBase O/R mapping features, such as delegated database access and the like, a user must install the generic CMP with the CocoBase CMP installer tool, which is an optional component of the CocoBase software package. This tool will configure the CMP EJB to run in most commercially available EJB servers that support container managed persistence EJBs and coordinate the database access with the CocoBase runtime libraries.

Clicking Next> in the Generic EJB Entity Bean CMP—All Parts drop down wizards of CocoAdmin will present a user with a list of attributes which comprise the maps and any references (e.g. foreign keys) to other maps that may be navigated by CocoBase. For example, in an e-commerce shopping cart example, a Customer map, which is generated against a selected relational database connection, might be selected, and the PkgName: field might contain the name testpkg so the resulting Java code will be generated to a package and directory named testpkg. In a subsequent pop-up dialog, the user can add a foreign key reference by clicking on Insert Attribute and filling in the foreign key attribute in the inserted row. Such references can be added automatically for any operation which contains a join across tables of different maps. This topic is covered in more detail in the CocoBase Programmer's Guide.

Customizing Attributes to be Generated in Java Code by CocoAdmin

Attributes that are to be generated into the Java code by CocoAdmin can be customized through the code generation screen of CocoAdmin, which is displayed when a map is selected from the wizard connections tree and the Next >button is pressed.

For each fixed Map Attribute Label in the leftmost column of the table corresponding to a selected map, the corresponding Java Attribute Name and Field Type are editable. When the Field Type field item is placed in edit mode, the CocoAdmin user can select one of the available data types from the drop-down list. These relational data types will be mapped to a corresponding Java type when the code is generated. A relational to Java conversion table can be found in CocoBase Programmer's Guide, but any functional conversion table may be used. If foreign key references are present, each entry of the reference is also editable.

In general, the attributes for Java code to be generated should not be customized here unless a foreign key relationship needs to be modeled that isn't described by the database foreign keys or that isn't described correctly. Database foreign keys are automatically included in the map if the Fore ignKeys checkbox in the wizard connections window is checked. Editing a map to include foreign key relationships is covered in the CocoBase Programmer's Guide.

A CocoAdmin user can specify a key for the map for the purposes of code generation by checking the box under the Key column. The attribute corresponding to the checked key box will be used as a key for the map and more than one box can be checked. For non-EJB applications, it is not necessary to specify a key, but keys can be useful in applications such as object caching and should contain unique values. Because EJBs require a unique key (for example, see the EJB spec. 1.0 from Sun Microsystems), CocoAdmin will not let a user generate code for an EJB without first specifying a key.

Customizing an Output Filename for Generated Java Code

When a map is generated into Java code by CocoAdmin, the output class name is specified manually by entering it in the File name field. If no filename is entered, the user will receive an error message when the user attempts to generate the Java code. Generally the user should adhere to Java naming conventions when naming package components. Package components should be saved in the PackageName directory and Java class files should have the form Classname or ClassName.java when entered into this field.

A CocoAdmin user can specify an existing output directory for the generated class (generated code) from the Look in: drop-down dialog. If from a previous window, the user specified a package prefix for the source code, then a subdirectory matching the prefix name can automatically be created in the specified output directory, if one does not already exist. Further information on naming and naming customization is presented in sections of the CocoBase Programmer's Guide.

Generating Java/EJB Code Using CocoBase

Once a filename has been entered as described above, a CocoAdmin user can generate the Java code by clicking the Generate button. When the Java Class or EJB has been generated, a dialog box indicating a successful generation will be displayed. If a user attempts to generate an EJB without specifying a key attribute, anCode Generation Exception Key must be specified! error messageis received. Likewise an error message may be received if a file already exists with the filename that was specified by the user for code generation.

Prior to code generation maps of CocoBase may be customized to add relationships between fields, objects, and beans by creating links. Relationships between objects such as 1 to 1, 1 to many, and many to many may be set. Among other relationships, parent child class relationships are supported. Code may be generated which reflects such relationships. Also, during the code generation step relationships may be added using wizards and interfaces of CocoAdmin.

Link information can be dynamically entered and edited with a CocoAdmin dialog, or it can be loaded from the resources\CocoNavLink. properties file of CocoBase if code regeneration is going to occur often with the same class, and if keying in virtual foreign keys isn't practical. The database foreign keys are auto-detected at a table level, and can be edited using a CocoAdmin dialog if the Map name to be used is different from the default one generated using a table name.

Customizing Generated Code Through CocoBase Templates

The later versions of CocoBase Enterprise all have the ability to customize code generation through the use of multiple code generation templates. Templates are available from the tool through the CocoAdmin. properties configuration file. Each of the GENTEMPLATES name values found in a configuration file are comma delimited and specify the name of the code generation template to be used. The comma delimited file can be viewed using an ASCII text editor, for example. The “\” character which appears at the end of each line indicates a line continuation and is only relevant to the CocoAdmin tool. Name values present in this file can also describe a set of templates that will be processed simultaneously. The code generation list that appears in the tool by default includes, among other things, all of the major Java Application Server types, production of generic CMP, generate Java classes, generate JSP, and the like. See the current www.thoughtinc.com website for a more complete listing. The default Java object of the listing is a standard Java instance that implements the CocoBase interfaces. If a GemstoneJ EntityBean using Proxy objects is selected, for example, CocoAdmin will generate all of the GemstoneJ files necessary for a Bean Managed Persistent EJB Object. Such an “All Parts” template reference will actually cause several files to be generated. Such a selection would have a CocoAdmin. properties entry that specifies which template files are to be processed, and in what order to process them. Such a file might be found in the thought\cocodemos3tier31\demos\resources directory of a particular version of the installed CocoBase software package. In one embodiment of the invention, when a particular template is picked any file prefix/suffix values to be appended to the filename would also be prefixed or appended to the map name automatically.

Mapping from One Data Source Format to Another Data Source Format

In another embodiment the invention provides a system for mapping from a first database format to a second database format, or from one database to another database of the same type, as a way for transferring data or synchronizing data sources. The system includes: data in the first database format stored in the system; rules for translating from the first format to the second format stored as a separate structure from the data; and means for applying the rules to the data to obtain the second format. This system may include a means for transferring the data from a first data source to a second data source. In one embodiment this system includes a simple computer program in a computer language such as Java, which reads the data from the first database using a repository map that may optionally be cached in the computer memory of the system and then stores the accessed data to a second database using the same or a different repository map.

An example of the structure for such a system and a short description/outline for a computer program adapted to such a system that is capable of transferring data between a first data source and a second data source might be described as follows:

First, let us assume two databases: a first database (B1) and a second database (B2) wherein B1 and B2 have the different corresponding data map schemas (S1) and (S2), respectively, and wherein S1 and S2 have the two corresponding schema repositories (R1 and R2) that include maps defining the structure (schema) of the database, Java object information (Java object model and any relationships between Java objects of the Java object model, or defining both the database and Java object information.

M1 is a map (or maps) defining the database schema S1 of R1 including map (or maps) with definitions for relationships between Java objects corresponding to the data of B1, and

M2 is a map (or maps) defining the database schema S2 of R2 including map (or maps) with definitions for relationships between Java objects corresponding to the data of B2.

The sample program outline,

(i) open a first system connection to access RI and read M1

(ii) open a second system connection to access R2 and read M2

(iii) have a Java application create a Java object (Obj-1) in memory that can access the data of B1

(iv) allow the Java application to connect to B2 and access B2, or have the Java application create a Java object (Obj-2) in memory that can access the Obj-1 and also access B2,

(v) open B1 and B2

(vi) have Obj-1 retrieve data from B1 and place data in Obj-1

(vii) optionally have Obj-2 obtain data from Obj-1

(viii) have the Java application access B2 (optionally through Obj-2) and store the data of Obj-1 or Obj-2 in B2

(ix) clear Obj-1 and possibly Obj-2, or create a new instance of Obj-1 and possibly of Obj-2

(x) repeat steps (vi)-(viii) until all of the data is transferred from B1 to B2

(xi) close B1 and B2 and any other open files, and

(xii) end program.

In one preferred embodiment, step (vii) as described above involves having data retrieved by Obj-1 and then converted to an XML format data file which is then forwarded to a different location (and optionally simultaneously to a different user) on a distributed network, whereupon an existing or new instance of Obj-2 is populated with data from the forwarded XML format data file and Obj-2 then stores the data in B2. The XML format data file may be simply of a Java object, the data than can be stored in a Java object, or both the Java object and its data.

The above procedures implement a dynamic mapping layer in an exchange format such as XML that can directly exchange data from two data sources in a more dynamically controllable fashion to each other for the purposes of data import, export and exchange without the requirement of an intermediate third object. In such a model the developer would not be constrained by the structure of the database to which or from where the data is being transferred.

Also, the above example is an example of object to “DataSource” mapping. Data may be mapped to (or from) object and relational databases and may also be stored in XML. Also, XML stored maps can be utilized by CocoAdmin as a resource from which to generate object code for user applications. In one implementation, two system users (same or different system) using a single (or several major recognized) XML standard(s), can export or import (as XML files) either or both of the XML map definitions (relationships of data) and data (dataset) of the database. This would permit a user to distribute parts or all of a dataset (and/or maps) to a distributed network, or to multiple network users in useable XML format files. Such a phenomenon may be referred to generically as O/X mapping (object to XML) or R/X (relational to XML) in addition to O/R (object to relational mapping).

In one embodiment, O/X mapping step would permit importation or exportation of data (that was converted to XML) from XML to and from any business object. For example, data from any business implementation object could be exported as XML along with its relationships as defined by the mapping tool. This would implement a more flexible and dynamic mapping facility for taking XML datasets and using them to populate object instances other than the original ones that may have created the data. One good example of such an implementation would be to take a first XML document that is presented as a user screen interface to a dataset and utilize the information (dataset) populating the first XML document to seamless populate a second XML document (datasource to datasource via a XML (or another exchange format similar to XML) translation step.

There are many ways to utilize the above implementations as part of either uni-directional or bi-directional mapping. Intranets and e-commerce applications can both take advantage of these important features. There are distinctive advantages when using a dynamic mapping layer where a java object provides translation by mapping such objects of a first data source (relational or object database) and also mapping such object to an XML or other second format data source. This allows more developer control as to how datasets are exchanged, filtered and/or validated between a first data source and a second data source.

One business use would be for a first party to use XML as a data export document to send information to a second party (e.g., items offered for sale) and the second party would import that information in order to generate a second XML data document (e.g., purchase order) that the first party can import. This would provide a much needed exchange format for the newly developing business to business market that might be able to rely on standardized XML data formats and avoid problems caused by object programming models that may vary widely from company to company.

Such a dynamic mapping facility would provide a critical missing facility to easily translate data models and object model into a format that can be readily used by business to business companies, or by the same company for department to department interactions.

Documents describing the use of CocoBase products that do mapping of data sources other than relational databases have been published, and such products may be used in conjunction with the above embodiments. Examples of mapping include, mapping from object to object databases and from COBOL (mainframe computers of businesses often use this language data source) to object. See the IBM “white paper” on the topic of COBOL to object mapping (may be downloaded from URL http://www.thoughtinc.com/websphere.html).

In one embodiment of the system of the present invention a translation layer translates between an object application (or a potential object application, i.e. an object model) to at least one relational database which includes data entries organized as tables and records. Examples are database architectures supported by companies such as Oracle, Sybase, Informix, etc. Such an organization is well-suited for manipulation by relational query languages such as SQL. However, the traditional relational database organization is not ideally suited for manipulation by an object-based system. Some tools, such as Java Database Connectivity (JDBC) exist to achieve some degree of indirect relational to object mapping by accommodating some differences between an object model or application and the structure of the relational database. However, these tools also have drawback in that they are often not scalable, require extensive manual recoding for different object applications and are complex to use. Even tools (often mistakenly referred to as object to relational, i.e., O/R tools) that generate JDBC code (instead of generating a pure SQL string that a JDBC driver can utilize to subsequently create a pure SQL statement or query bundled in a JDBC format) are limited since they are often application specific, database specific, or specific to both.

In one preferred embodiment, a translation or abstract layer communicates with at least one JDBC (relational database driver) and at least one primitive Extended Java Bean (EJB) construct. The function of such a translation layer (generally called the O/R layer in CocoBase documentation, for example) is to translate object-based queries for the data into queries that JDBC can, translate into queries for a relational database. In a preferred embodiment, the translation layer can generate an SQL string (or strings) based upon the object-based queries, which can be passed to at least one JDBC, which JDBC can then generate an SQL statement from the SQL string. Similarly, the abstract layer accepts results from the queries and provides them to one or more of the EJB constructs in a suitable object format. The existence of JDBC is not necessary for all implementations of the invention. Different types of databases, data models, computation architectures, and the like can be used within the basic principle of the present invention. This mapping can be one-to-one, many-to-one, many-to-many, or any variation.

Another preferred embodiment of the present invention allows for mapping tables to be plain text, or text-based XML repository files. This not only allows the maps to be human readable and editable with standard editions, email programs, web browsers, etc., but allows for easy transportability and delivery of the maps.

Another feature of the maps is that they can be dynamically loaded into a computer system to provide for new dynamic mapping in a system that can that can continue to run while the new maps are loaded and executed. As described supra, the use of the translation maps provides advantages in organization, standardization of interfaces, efficiency of design, compatibility, scalability, portability and other advantages. The system of the '197 patent provided an entire set of tools to simplify and improve an operators ability to manipulate the maps without requiring high levels of programming knowledge or database query language familiarity.

In part, the present invention is based upon a translation operation derived from the operation of U.S. Pat. No. 5,857,197, and depicted by the flow chart at FIG. 1. At step 1(a) the application software is operating, and reaches a point where data must be accessed to continue the operation. For purposes of example, the application software is object oriented, and is being run by a customer at a customer location. However, the application software need not always be limited to object orientation. Rather, other types of software models can be facilitated by the present invention to be described herein.

Once the application software reaches a point that data is needed, for example, a production database or data store, which is not at the site of the application or controlled by the application user, then a request 2(a) is made for that data.

As described in great detail in U.S. Pat. No. 5,857,197, when an object application makes a request for data such as 2(a), then certain object information is sent to a location whereby the necessary data can be accessed. Such activities may be coordinated or regulated by a transaction coordinator facility of an object application server.

The object information provided the object application is received in an abstract layer, also known as a translation layer, at step 4. At this point, an analysis takes place to extract certain information regarding the object sent by the object application. This information is used to select and manipulate a particular metadata maps provided by a data manager, which handles the data store containing any information required by the object application.

Operating entirely independent of the application software is the data manager. The data manager carries out an analysis of the arrangement of data in a data store controlled by the data manager at step 1(b). Depending upon the size of the data manager and the data store, any number of analyses can be carried out to help facilitate access by parties interested in the data held by the data store.

The result of this analysis is the development of a metadata map or maps based upon generated object characteristics of the arrangement of the data store. Depending upon the size and arrangement of the data store, any number of metadata maps can be generated. The number of generated object characteristics, which would be the basis of the metadata maps depends upon the data manager operator, and his/her response to the requirements and characteristics of those seeking access to the data store.

At step 3 a metadata map or metadata maps, based upon the object characteristics of the arrangement of the data store, are generated. The number and characteristics of these maps depend upon the characteristics of the arrangement of the data store, and the responsiveness of the data manager operator to the various types of demands for data by object applications. Each metadata map provides the necessary means to obtain data or particular types of data from the data store. It should be noted that in many cases there are many object characteristics can be derived from a relational data store. The data related to particular derived object characteristics that can be accessible using a metadata map generated for a selected group of object characteristics.

The operation of the object application and the management of the relational data store come together at step 5. At this point, an evaluation is made between the object information provided from the object application and object characteristics associated with the metadata map available in the data manager. The evaluation results in a selection of at least one metadata map appropriate for the object characteristics sent from the application. The selected metadata map is used to navigate through the data store to obtain data that is desired for the object application at step 6. It should be noted that more than one metadata map can be used to obtain data from the data store.

Once the data is obtained, it is sent back to the requesting object application at step 7. It should be noted that as described in U.S. Pat. No. 5,875,197, step 6 of obtaining data and step 7 of sending data are constituted by a much greater number of sub-steps. These include: generating demands from the metadata map; executing the commands used by the metadata map; obtaining data from the data store in response to the command; processing the data access from the data store using the metadata map; packing and manipulating the data for transmittal; unpacking the data; instantiating objects using the accessed data and returning the instantiated objects to the object application for further processing. It should be noted that the results of the overall data accessing process may contain many rows of data which can be used to instantiate a plurality of objects.

An important purpose of the aforementioned system is to achieve a high degree of flexibility with dynamic mapping to objects as they occur in object applications. Accordingly, it may become necessary to handle a plurality of objects at any one time, and obtain the necessary data to instantiate or otherwise satisfy requirements of each of the objects addressed in the object application. However, large amounts of data associated with each object may become cumbersome. Further, a single map for plural objects may also become awkward to handle.

Evaluation of object characteristics sent by object applications can often be time-consuming while not resulting in the selection of the best metadata map, and thus the most appropriate data may not be accessed. Further, depending upon the amount of data available in a data store and the number of metadata maps available, the selection process may become very slow and cumbersome.

However, there is a definite need for translating between a wide variety of different data formats, other than just the relational to object translation of the basic system of U.S. Pat. No. 5,857,197. There is also a need for transmitting quickly and easily between various types of databases. Further, there is also a need for editing or otherwise altering data exchanged between databases for the purpose of facilitating object applications. The basic system of U.S. Pat. No. 5,857,197 needs further support to facilitate expeditious operation, both for its basic system and for modifications to its system that will accommodate better security and for selectivity of data.

Accordingly, there will be a substantial advantage in generating XML data documents for exchange between parties to carry out commercial transactions. Conversion to XML will also facilitate the use of data sources or data architecture other than relational databases. Examples of such mapping include object-to-object mapping and JAVA to object mapping. Once algorithms translating between XML and object formats are standardized, translations between any type of system can take place seamlessly and very quickly. Mapping can also include the use of JAVA Server Page (JSP) format.

Once editing has took place either for the metadata maps or even the production data from the datastore, changes can be recorded in the operation of snapshots so that a record of the map or other data at various times can be studied. As a result, data management paradigms can be developed. Normally such snapshots are made at the location of the party requesting the data (such as the object application user) once map modification is completed. The modified files can then be placed in a source code management system.

The dynamic mapping of the present invention can be applied where a Java object provides translation by mapping such an object to first data source (either relational or object) can also by mapping such an object to an XML for a second format database. This arrangement allows greater control as to how the data steps are exchanged, filtered, and validated by exchanging data.

While a number of preferred embodiments of the present invention have been discussed by way of example, the present invention is not to be limited thereby. Rather, the present invention is to be construed as including any and all variations, modifications, permutations, adaptations and embodiments that would occur to one skilled in this art once having been taught the present invention.

I claim:

1. A micro computer system comprising at least one data source and a mapping system wherein object programming applications are tailored to delegate both the accessing of a data source and the generation of SQL strings to a runtime library repository, which repository can access the database directly or through a database driver, such as a JDBC driver, without the need to embed specific database accessing mechanisms in the application code.

2. A system according to claim 1, wherein the micro computer system is an embedded device that is a portion of a larger system other than a traditional desktop or laptop computer.

3. A system according to claim 2, wherein the embedded system is a portable or cellular phone, an automobile computing system, part of a home electronic sound or entertainment system, a portable sound or entertainment system, an electronic security system, a smart video game console, or a combination thereof.

4. A system according to claim 1, wherein the micro computer system is a standalone computer system other than a traditional mainframe, desktop, or laptop system.

5. A system according to claim 4, wherein the standalone computer is smart mobile phone, a personal organizer, a portable stock market trading device, a hand held computer or a PDA.

6. A system according to claim 5, wherein standalone computer is adaptable to or includes portable internet access.

7. A system according to claim 1, having a concurrent parameter setting mechanism wherein the runtime library repository can be set to access a particular data source and to generate data source specific database calls and SQL strings.

8. A computer system according to claim 1, wherein the mapping system portion is designed to provide different maps for particular objects to different users and does not permit direct access of computer system users to JDBC drivers for any mapped data sources of the computer system, and wherein the mapping system provides varying levels of access to the mapped data sources for at least two different users of the same system, whereby a user only has access to a particular list of maps that are available to the security level of that user.

9. A computer system according to claim 1, wherein the mapping system portion is designed to provide to a system user who is accessing, creating or updating maps, or accessing objects on a system to make data changes related to a particular object and to promulgate the changes to that object as either local or global changes on the computer system.

10. A computer system according to claim 9, wherein the mapping system portion provides an interface permitting an authorized user to edit or create the tables, fields, or attributes of a data map for an object as a table format or XML file format without requiring the user to have extensive knowledge of a particular relational database as a source of the data, or extensive knowledge about how to directly access that relational database.

11. A computer system according to claim 1, wherein the mapping system provides an interface and features that permit a user to access, create, or update the metadata of a map as a dynamic computer system update, without requiring the user to either open a new connection to the data source or to restart an object application program that is running while the user is dynamically evaluating or changing metadata for a map, and wherein the metadata of a map that a user can dynamically evaluate or change includes a map description of data or relationships between data, and wherein such map description is at least one member selected from the group consisting of a data source relationship, a relationship between at least two objects of an object application, and both a data source relationship and a relationship between at least two objects of an object application.

12. A local or distributed computer system which is an intranet, internet or satellite communicated system, wherein the local or distributed system includes a micro computer system or an embedded system comprising a fully synchronized data system and an O/R repository that permits persistence and synchronizing of data between a data source on the micro computer system and a main data source on a larger computer system.

13. The computer system of claim 12, further comprising a mapping system wherein object programming applications are tailored to delegate both the accessing of a data source and the generation of SQL strings to a runtime library repository, which repository can access the database directly or through a database driver, such as a JDBC driver, without the need to embed specific database accessing mechanisms in the application code, and wherein the persistence manager calls the mapping system and in the call delegates accessing or updating of data in the data source to the repository layer, and wherein the a persistence monitor does not complete a transaction until it is notified by the mapping system that a data source has been updated by the mapping system such that any changes to the data will automatically be synchronized with the primary data source or record upon completion, including commit or roll-back of changes for both data sources.

14. The computer system of claim 13, wherein at least one temporary data source can be set up on a microcomputer system or embedded system and is synchronized with the persistence monitor with a data source on a larger system wherein the larger system can be accessed by a JDBC driver and is not merely a duplicate of the micro computer system data source.

15. A object language software program that can run in a micro computer system according to claim 1, or in a virtual machine that emulates such a micro computer system, and can generate application programming code from database maps and thereby provide a programming application that will run on a micro computer system, which delegates to a runtime library repository both of the functions of accessing a database and generating SQL strings that are specific to a database or to a JDBC driver for a type of database.

16. An object language software program according to claim 15, wherein the runtime library repository can be modified and tailored to optimize database access calls and to optimize the generation of SQL strings for a particular database.

17. An object language software program according to claim 16, wherein the software program provides the ability to synchronize internal data and/or objects on the micro computer or virtual machine emulator system with an external data store and to provide transparent persistence of data and/or objects between the internal and external data stores.

18. An object language software program according to claim 17, wherein the synchronization and transparent persistence is implemented through communication between directly connected systems or by indirectly communicated machines via telephone, intranet, internet, or satellite communication, or through a combination thereof.
